(19) United States
(12) Patent Application Publication
(10) Pub. No.: US 2026/0185691 A1
(43) Pub. Date: Jul. 2, 2026

(54) LED SYSTEM AND METHOD WITH REMOTE HEAT DISSIPATION UNIT

(71) Applicant: NBCUniversal Media, LLC, New York, NY (US)

(72) Inventor: Charles Edwards, Mesa, AZ (US)

(21) Appl. No.: 19/381,683

(22) Filed: Nov. 6, 2025

Related U.S. Application Data
(60) Provisional application No. 63/740,492, filed on Dec. 31, 2024.

(51) Int. Cl. F21V 29/58; F21V 23/00; F21V 29/503; F21V 29/60; F21V 31/00; F21Y 115/10

(52) U.S. Cl. CPC F21V 29/59; F21V 23/002; F21V 23/008; F21V 29/503; F21V 29/58; F21V 29/60; F21V 31/005; F21Y 2115/10

(57) ABSTRACT

A light-emitting diode (LED) system includes a head having a plurality of LEDs, a heat dissipation unit remote from the head, and an umbilical having at least one flow path configured to guide a liquid between the heat dissipation unit and the head.

### CROSS-REFERENCE TO RELATED APPLICATIONS

This application claims priority to and the benefit of U.S. Provisional Application No. 63/740,492, entitled “LED SYSTEM AND METHOD WITH REMOTE HEAT DISSIPATION UNIT,” filed Dec. 31, 2024, which is incorporated by reference herein in its entirety for all purposes.

### BACKGROUND

The present disclosure relates generally to techniques for cooling a light-emitting diode (LED) system. More specifically, the present disclosure relates to techniques for remote liquid cooling of a relatively high-powered LED system (e.g., 500 Watts or greater).

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A traditional LED system may include, for example, a head having a plurality of LEDs, a driver assembly configured regulate power to the LEDs, and a heat dissipation unit. A size and/or weight of the head and associated componentry, such as the driver assembly and/or the heat dissipation unit, tends to increase with a power rating of the LED system. For at least these reasons, among others, relatively high-powered LED systems (e.g., 500 Watts or greater) are impractical due to size, weight, and/or immobility. It is now recognized that improved systems and methods are desired.

### BRIEF DESCRIPTION

Certain examples commensurate in scope with the originally claimed subject matter are summarized below. These examples are not intended to limit the scope of the claimed subject matter, but rather these examples are intended only to provide a brief summary of possible forms of the subject matter. Indeed, the subject matter may encompass a variety of forms that may be similar to or different from the examples set forth below.

In an aspect, a light-emitting diode (LED) system includes a head having a plurality of LEDs, a heat dissipation unit remote from the head, and an umbilical having at least one flow path configured to guide a liquid between the heat dissipation unit and the head.

In another aspect, a method of cooling a light-emitting diode (LED) system includes guiding a liquid between a head having a plurality of LEDs and a heat dissipation unit remote from the head via at least one flow path defined by an umbilical, rejecting heat from the plurality of LEDs to the liquid, and rejecting heat from the liquid via the heat dissipation unit.

In still another aspect, a light-emitting diode (LED) assembly includes a head, a plurality of LEDs disposed in the head, an umbilical interface disposed in, disposed on, or coupled to the head, an inlet of the umbilical interface, an outlet of the umbilical interface, a liquid input cavity within the head, wherein the liquid input cavity is configured receive a liquid from the inlet of the umbilical interface, and a liquid output cavity within the head, wherein the liquid output cavity is configured to output the liquid to the outlet of the umbilical interface.

### BREIF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating a light-emitting diode (LED) system, the LED system including an LED assembly with an LED head and associated componentry, and the LED system including a heat dissipation unit remote (e.g., physically discrete) from the LED head of the LED assembly, in accordance with an aspect of the present disclosure;

FIG. 2 is a schematic illustration of a portion of the LED system of FIG. 1, where the LED head of the LED assembly is configured for liquid immersion cooling of LEDs disposed in the LED head, in accordance with an aspect of the present disclosure;

FIG. 3 is a schematic illustration of a portion of the LED system of FIG. 1, including a heat sink fluidly sealed from LEDs disposed in the LED head, in accordance with an aspect of the present disclosure;

FIG. 4 is a schematic illustration of an LED system including a plurality of LED heads corresponding to a plurality of LED assemblies, and including a heat dissipation unit remote (e.g., physically discrete) from the plurality of LED heads corresponding to the plurality of LED assemblies, in accordance with an aspect of the present disclosure;

FIG. 5 is a front perspective view of a portion of the LED system of FIG. 1, where the LED head of the LED assembly is coupled to an umbilical (e.g., flexible umbilical) configured to extend to a remote heat dissipation unit, in accordance with an aspect of the present disclosure;

FIG. 6 is a back perspective view of the portion of the LED system of FIG. 5, in accordance with an aspect of the present disclosure;

FIG. 7 is an exploded front perspective view of the portion of the LED system of FIG. 5, in accordance with an aspect of the present disclosure;

FIG. 8 is an exploded back perspective view of the portion of the LED system of FIG. 5, in accordance with an aspect of the present disclosure;

FIG. 9 is a cross-sectional perspective view an LED assembly including an LED head of the portion of the LED system of FIG. 5, including illustration of a fluid pathway through LED head, in accordance with an aspect of the present disclosure; and

FIG. 10 is a process flow diagram illustrating a method of operating the LED system of FIG. 1 and/or the LED system of FIG. 4, in accordance with an aspect of the present disclosure.

### DETAILED DESCRIPTION

One or more specific examples of the present disclosure will be described below. In an effort to provide a concise description of these examples, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various examples of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates generally to techniques for remote liquid cooling of a relatively high-powered (e.g., 500 Watts or greater) light-emitting diode (LED) system. For example, it is presently recognized that relatively high-powered LED systems require relatively large and/or heavy driver assemblies, heat dissipation units, or both. The size and/or weight of the driver assembly, the heat dissipation unit, or both renders traditional LED systems practically immobile beyond a threshold power rating, such as 500 Watts.

In accordance with an aspect of the present disclosure, the LED system physically offsets the driver assembly and/or the heat dissipation unit from a head of the LED system, where LEDs are disposed in the head. For example, the driver assembly may be integrated with the heat dissipation unit. An umbilical (e.g., a flexible umbilical) may extend between the heat dissipation unit and the head. The flexible umbilical may include wiring configured to electrically couple the driver assembly with the LEDs in the head. Further, the flexible umbilical may include at least one flow path configured to guide a liquid (e.g., a cooling liquid) between the heat dissipation unit and the head.

In certain aspects of the present disclosure, the liquid, such as a transparent, non-corrosive, thermally conductive dielectric liquid (e.g., an oil), is guided by the flow path (e.g., a first flow path) into the head and in contact with the LEDs for immersion cooling of the LEDs. In certain other aspects of the present disclosure, the liquid, such as a water-based coolant, a glycol-based coolant, or a mixture of water and glycol is guided by the at least one flow path (e.g., a second flow path) to a heat sink within the head of the LED system or coupled to the head of the LED system.

As heat is transferred from the LEDs and/or the heat sink to the liquid, the liquid is guided by the at least one flow path to the heat dissipation unit. Heat is dissipated from the liquid at the heat dissipation unit, for example, by an air flow generated via a fan of the heat dissipation unit. In this way, the liquid is cooled at the heat dissipation unit for return toward the head of the LED system. A pump is employed to bias the liquid through the at least one flow path.

By removing the heat dissipation unit and/or the driver assembly (which may be integrated with the heat dissipation unit) from the head of the LED system, a size and/or weight of the head is considerably reduced less than traditional configurations of a similar power rating having the heat dissipation unit and/or the driver assembly physically integrated with the head. Additionally or alternatively, relatively high powered LED systems (e.g., 500 Watts or greater, 2000 Watts or greater) that otherwise would have been impractical with traditional configurations are made practical in real world applications by way of the remote heat dissipation unit (e.g., including the driver assembly). These and other aspects of the present disclosure are described in greater detail below with reference to the drawings.

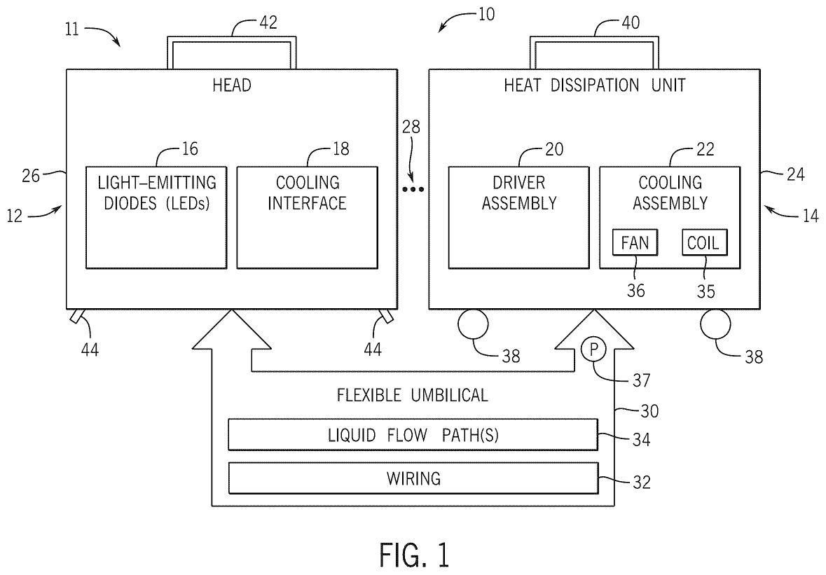

FIG. 1 is a block diagram illustrating a light-emitting diode (LED) system 10 having an LED assembly 11 with an LED head 12, referred to in certain instances of the present disclosure as “a head” for brevity, including various componentry disposed in, disposed on, or otherwise integrated with the LED head 12, and a heat dissipation unit 14 remote from the LED assembly 11, in accordance with an aspect of the present disclosure. It should be understood that the illustrated sizes, shapes, orientations, and/or locations of componentry of the LED system 10 in FIG. 1 should not be taken as limiting on aspects of the present disclosure, as FIG. 1 is merely a block diagram to illustrate examples of various componentry that may be included in the LED system 10.

In FIG. 1, the LED assembly 11 of the LED system 10 includes, among other possible componentry, LEDs 16 disposed in the LED head 12 and a cooling interface 18 disposed in (or otherwise integrated with) the LED head 12, where the cooling interface 18 is configured to facilitate cooling of the LEDs 16. The LEDs 16 may include one or more colors, such as up to six different colors of LEDs (e.g., warm white, one or more white blends, red, green, and blue), associated with different driver channels. In certain aspects of the present disclosure, the LED assembly 11 of the LED system 10 is configured for liquid immersion cooling of the LEDs 16. That is, the cooling interface 18 may include a space (e.g., a cavity) defined in the head 12 of the LED assembly 11 and immediately adjacent to the LEDs 16, such that a cooling liquid (e.g., a thermally conductive dielectric liquid, such as an oil) is provided to the space and directly contacts the LEDs 16 for extracting heat from the LEDs 16. Additionally or alternatively, in certain aspects of the present disclosure, the cooling interface includes a heat sink fluidly sealed from the LEDs 16 to block exposure of the LEDs 16 to a cooling liquid (e.g., a traditional coolant and/or a water-based liquid, such as water or a mixture of water and glycol). The heat sink, if included, may be disposed in the head 12, mounted to an exterior surface of the head 12, or otherwise integrated with the head 12. In some aspects of the present disclosure, the LEDs 16 may be coated with a non-oil liquid.

Continuing with FIG. 1, the heat dissipation unit 14 of the LED system 10 may include, among other possible componentry, a driver assembly 20 configured to regulate power to (and, in certain instances, control of) the LEDs 16 in the head 12 and a cooling assembly 22. The driver assembly 20 includes, for example, drivers, driver electronics, power supply, and/or a controller. As shown, a body 26 (e.g., an enclosure or shroud) of the heat dissipation unit 14 may be physically discrete from aspects of the LED assembly 11, such as a body 26 (e.g., an enclosure or shroud) of the head 12. That is, the body 24 of the heat dissipation unit 14 may be separated from the body 26 of the head 12 by a space 28. An umbilical 30 (e.g., a flexible umbilical) extending between the head 12 of the LED assembly 11 and the heat dissipation unit 14 may be employed to electrically couple the driver assembly 20 at the heat dissipation unit 14 to the LEDs 16 at the head 12, and to guide a cooling liquid between the cooling assembly 22 at the heat dissipation unit 14 and the cooling interface 18 at the head 12. For example, the flexible umbilical 30 may include wiring 32 configured to electrically couple the driver assembly 20 to the LEDs 16, and the flexible umbilical 39 may include one or more flow paths 34 (e.g., one or more liquid flow paths) to guide the cooling liquid between the cooling assembly 22 and the cooling interface 18. As an example, the one or more flow paths 34 within the flexible umbilical 39 may include a first flow path configured to guide the cooling liquid from the heat dissipation unit 14 to the head 12 of the LED assembly 11, and a second flow path configured to guide the cooling liquid from the head 12 of the LED assembly 11 to the heat dissipation unit 14. The wiring 32 extending through the flexible umbilical 39, such as a wiring cavity in the flexible umbilical 39 separate from the first and second flow paths described above, may include, for example, all driver wiring (e.g., for each driver channel), power wiring, and/or data wiring (e.g., via a bus) between the driver assembly 20 and the LEDs 16.

In certain aspects of the present disclosure, the cooling assembly 22 includes, for example, a coil 35 and a fan 36, where the coil 35 forms a part of (or is otherwise coupled to) the flow path(s) 34 of the flexible umbilical 30. The coil 35 may receive the cooling liquid and the fan 36 may generate an air flow over the coil 35 to establish a heat exchange relationship between the cooling liquid and the air flow. In this way, the air flow extracts heat from the cooling liquid at the coil 35, thereby reducing a temperature of the cooling liquid as the cooling liquid is returned to the cooling interface 18 at the head 12 for extract heat from the LEDs 16.

Other cooling techniques via the cooling assembly 22 and/or other componentry of the LED system 10 are also possible in accordance with the present disclosure. For example, the cooling assembly 22 may employ liquid-to-liquid cooling in certain aspects of the present disclosure. Additionally or alternatively, the flexible umbilical 30 may include one or more active heat dissipation structures and/or one or more passive heat dissipation structures configured to dissipate heat from the cooling liquid. As an example, the flow path(s) 34 formed in or by the flexible umbilical 30 may include at least one surface having a material composition, such as aluminum and/or copper, well suited and/or selected for extracting heat from the cooling liquid and, in certain aspects of the present disclosure, dissipating such heat to environment. In certain aspects of the present disclosure, a first portion (or first flow path) of the flow path(s) 34 directing the cooling liquid toward the head 12 includes a first material composition configured to thermally insulate the cooling liquid, and a second portion (or second flow path) of the flow path(s) 34 directing the cooling liquid toward the heat dissipation unit 14 includes a second material composition configured to dissipate heat from the cooling liquid, thereby reducing an amount of work at the heat dissipation unit 14 for reducing a temperature of the cooling liquid prior to its delivery back toward the head 12. Additionally or alternatively, the flow path(s) 34 and/or the wiring 32 in certain aspects of the present disclosure may include heat shielding features configured to shield heat in the cooling liquid from the wiring 32, thereby reducing, mitigating, or negating possible negative effects associated with the wiring 32 exceeding a threshold temperature. As an example, the wiring 32 may be encapsulated by insulating material configured to shield the wiring 32 from excess temperatures and/or electrical arcing, shorting, and the like.

In certain aspects of the present disclosure, a pump 37 is configured to bias the cooling liquid through the flow path(s) 34 between the cooling interface 18 and the cooling assembly 22. The pump 37 may be coupled to or otherwise integrated with, for example, the flexible umbilical 30 or the heat dissipation unit 14. The flow path(s) 34 may include, for example, a first flow path (e.g., a first liquid flow path) configured to guide the cooling liquid from the cooling assembly 22 to the cooling interface 18 and a second flow path (e.g., a second liquid flow path) configured to guide the cooling liquid from the cooling interface 18 to the cooling assembly 22. Although the LED system 10 illustrated in FIG. 1 is described above in the context of a purely liquid cooling arrangement, it should be understood that two-phase cooling arrangements and/or traditional refrigeration componentry are also possible. For example, the LED system 10 may include, in certain aspects of the present disclosure, a cooling fluid that changes phases between a liquid and a gas (or a two-phase fluid) may also be employed, a flow biasing device equipped for handling a gaseous or two-phase fluid, or any combination thereof.

In general, detaching the driver assembly 20 and/or the cooling assembly 22 from the head 12 (e.g., by disposing the driver assembly 20 and/or the cooling assembly 22 in the heat dissipation unit 14, which is physically discrete and/or remote from the head 12) substantially reduces a size and/or weight of the head 12, while substantially improving a mobility of the head 12. Accordingly, aspects of the present disclosure make practical (e.g., mobile, lightweight, etc.) relatively high-powered LED systems (e.g., 500 Watts or greater, 2000 Watts or greater) that, under traditional configurations, would have been impractical. In certain aspects of the present disclosure, the heat dissipation unit 14 is also equipped with mobility features (e.g., one or more wheels 38, one or more handles 40, etc.) enabling mobility of the heat dissipation unit 14 away from the head 12. Additionally or alternatively, the head 12 may include a handle 42, one or more legs 44, and/or other features for moving, arranging, setting, and/or staging the head 12.

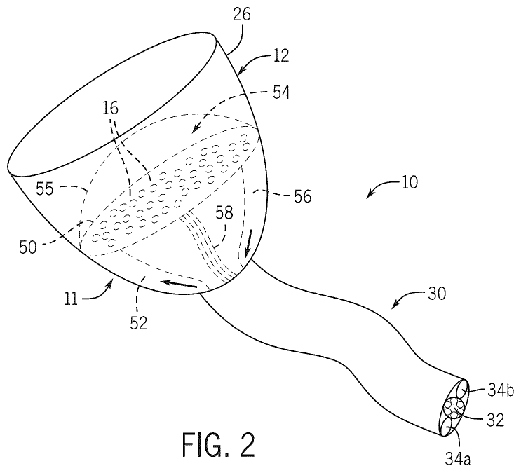

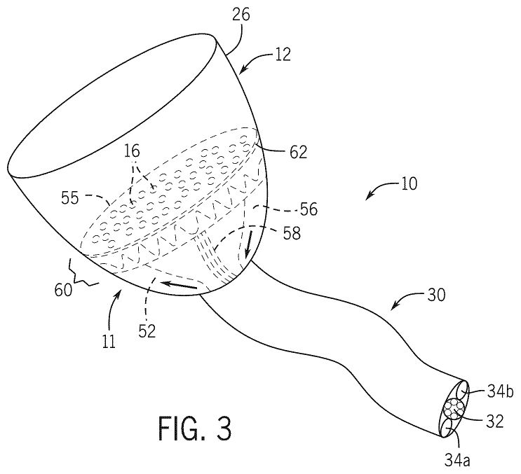

As previously described, the head 12 may be configured (e.g., via the cooling interface 18) for liquid immersion cooling or heat sink cooling. FIG. 2 is a schematic illustration of a portion of the LED system 10 of FIG. 1, where the head 12 of the LED assembly 11 is configured for liquid immersion cooling of the LEDs 16 disposed in the head 12, in accordance with the present disclosure. FIG. 3 is a schematic illustration of a portion of the LED system 10 of FIG. 1, including a heat sink 60 fluidly sealed from LEDs 16 disposed in the head, in accordance with the present disclosure.

Focusing first on FIG. 2, the flexible umbilical 30 includes, as previously described, the wiring 32 and the at least one flow path 34, such as a first flow path 34a (e.g., including a coolant supply to the head 12) configured to guide the cooling liquid toward the head 12 and a second flow path 34b (e.g., including a coolant exhaust from the head 12) configured to guide the cooling liquid away from the head 12. As shown, the LEDs 16 are disposed within (or otherwise integrated with) the body 26 of the head 12. In certain aspects of the present disclosure, the LEDs 16 are disposed on an LED wall 50 extending within or otherwise coupled to the body 26 of the head 12. The cooling liquid may be provided to a liquid input cavity 52 disposed in the head 12, which guides the cooling liquid toward the LEDs 16. For example, a liquid immersion cavity 54 fluidly coupled with (or comprising) the liquid input cavity 52 may receive the cooling liquid and cause the cooling liquid to directly contact the LEDs 16. The liquid immersion cavity 54 may be defined at least in part by one or more cavity walls 55, as shown. Additionally or alternatively, the liquid immersion cavity 54 may be disposed above the LEDs 16, below the LEDs 16, or a combination thereof. If the one or more cavity walls 55 extend above the LEDs 16, the one or more cavity walls 55 may be transparent.

In certain aspects of the present disclosure, the liquid immersion cavity 54 includes a labyrinth configured to expose the LEDs 16 to the cooling liquid for a desirable period of time for heat extraction from the LEDs 16. The cooling liquid then may be guided to a liquid output cavity fluidly coupled to the second flow path 34b in the flexible umbilical 30 for return of the cooling liquid to the heat dissipation unit (not shown in FIG. 2). The LED system 10 of FIG. 1 may employ a thermally conductive dielectric liquid (e.g., an oil) as the cooling liquid, since the cooling liquid comes into contact with the LEDs 16.

As previously described, the flexible umbilical 30 also includes the wiring 32 configured to be coupled to the LEDs 16 (e.g., directly or via a circuit board integrated, for example, with the LED wall 50). In certain aspects of the present disclosure, internal wiring 58 in the head 12 extends between the wiring 32 in the flexible umbilical 30 and the LEDs 16. It should be noted that FIG. 2 is a schematic illustration and should not be taken as representative of sizes, shapes, locations, orientations, and the like of componentry of the LED system 10.

In accordance with an aspect of the present disclosure, the thermally conductive dielectric liquid employed in the liquid immersion techniques described above operates to provide additional technical benefits beyond cooling, such as reducing, mitigating, or negating a possibility of electrical arcing. For example, if one or more of the LEDs 16 is wired for relatively low voltage (e.g., less than 60 VDC), the corresponding cable of the wiring 32 in the flexible umbilical 30 needed to carry sufficient power to each drive channel of the LED head 12 may be relatively thick. As an example, 2000 Watt channels at 40 VDC would need to carry approximately 50 Amps, requiring a relatively thick cable. If the voltage is increased to 200 VDC, then the cable could be relatively thin (e.g., 18 AWG cable) because it only needs to carry approximately 10 Amps. However, operating at high voltage can cause electrical arcing if air is the only insulator separating the LEDs 16. For example, one of the LEDs 16 (e.g., a color-driven LED) being driven at a relatively high voltage (e.g., 60 VDC or 200 VDC) could be right next to another of the LEDs 16 not being driven for a specific color. This would create a 60 VDC or 200 VDC potential between the pads of the two LEDs 16. To ensure no arcing in air, a relatively large gap (e.g., of multiple millimeters) would typically be needed, preventing compact LED sources being used at high voltage. In accordance with an aspect of the present disclosure, however, the thermally conductive dielectric liquid also acts as a dielectric insulator that would prevent high voltage arcing. That is, the thermally conductive dielectric fluid acts as an insulator, preventing high voltage arcing and/or enabling a spacing between adjacent LEDs of 0.5 millimeters to 1.5 millimeters. In this way, liquid immersion cooling enables remote cooling and the ability to use thinner wire gauge using the remote LED head 12 due to the dielectric characteristics of the coolant, along with a compact design of the LED head 12 operable at relatively high voltages compared to traditional configurations.

As previously described, a heat sink may be employed in lieu of (or in combination with) liquid immersion cooling. For example, in FIG. 3, the LED system 10 includes similar componentry as the LED system 10 in FIG. 2, except that the LED system 10 in FIG. 3 includes the heat sink 60 instead of the liquid immersion cooling features. The heat sink 60 may abut the LED wall 50 in (or on) which the LEDs 16 are disposed. The liquid input cavity 52 guides the cooling liquid toward and/or into the heat sink 60, and the liquid output cavity 56 guides the cooling liquid out of and/or away from the heat sink 60.

In certain aspects of the present disclosure, the heat sink 60 includes one or more passages configured to guide the cooling liquid therethrough. The heat sink 60 may be sealed from the LEDs 16 via one or more sealants 62 (e.g., one or more gaskets) such that the cooling liquid does not come into contact with the LEDs 16. While the heat sink 60 is illustrated within the body 26 of the head 12 in FIG. 3, it should be understood that the heat sink 60 may be mounted to the body 26 of the head 12, disposed partially inside and partially outside of the body 26 of the head 12, or otherwise integrated with the head 12 in one or more other ways in accordance with aspects of the present disclosure. Additionally or alternatively, the LED system 10 in FIG. 3 may employ traditional coolants, water, or a water-based mixture (e.g., water and glycol) as the cooling liquid, although other cooling liquids are also possible in accordance with the present disclosure.

As is the case in FIG. 2, the LED system 10 in FIG. 3 includes the wiring 32 of the flexible umbilical 30. The wiring 32 may couple (e.g., directly or indirectly) with the LEDs 16. As shown, for example, the internal wiring 58 may couple the wiring 32 with the LEDs 16 (or a circuit board adjacent the LEDs 16). In certain aspects of the present disclosure, a passage may be formed in the heat sink 60 to receive the internal wiring 58 and/or the wiring 32. It should be noted that FIG. 3 is a schematic illustration and should not be taken as representative of sizes, shapes, locations, orientations, and the like of componentry of the LED system 10.

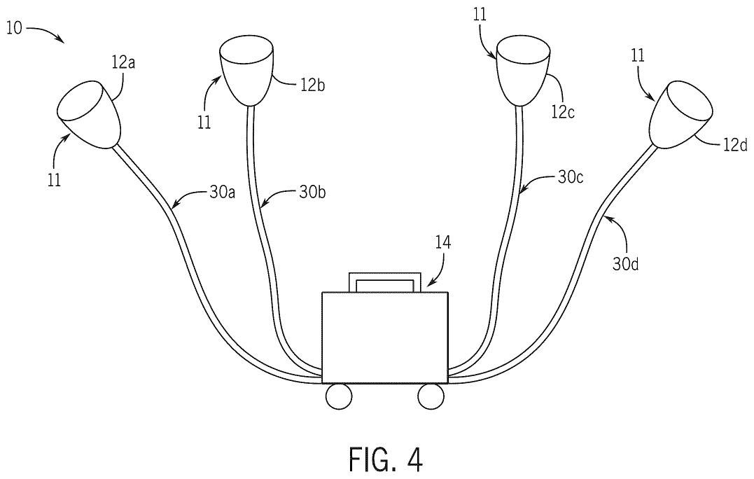

While the various LED systems 10 illustrated in certain aspects of the present disclosure include a single instance of the head 12 corresponding to a single instance of the LED assembly 11, it should be understood that multiple instances of the head 12 corresponding to multiple instances of the LED assembly 11 may be employed in the LED system 10. For example, FIG. 4 is a schematic illustration of the LED system 10 including a plurality of heads 12a, 12b, 12c, 12d and the heat dissipation unit 14 remote (e.g., physically discrete) from the plurality of heads 12a, 12b, 12c, 12d. Flexible umbilicals 30a, 30b, 30c, 30d are employed to couple the heat dissipation unit 14 with the plurality of heads 12a, 12b, 12c, 12d, respectively, as shown.

Each head of the plurality of heads 12a, 12b, 12c, 12d may include the same or similar liquid immersion cooling features illustrated in FIG. 2 and described above, or the same or similar heat sink 60 illustrated in FIG. 3 and described above. Further, each flexible umbilical of the plurality of flexible umbilicals 30a, 30b, 30c, 30d may include the same or similar features illustrated in FIGS. 1-3 and described above. Further still, the heat dissipation unit 14 may include the same or similar features illustrated in FIG. 1 and described above, except that the heat dissipation unit 14 in FIG. 4 may include multiple driver assemblies corresponding to each of the plurality of heads 12a, 12b, 12c, 12d (or a single integrated driver assembly for all of the plurality of head 12a, 12b, 12c, 12d). While FIG. 4 includes four of the heads (i.e., heads 12a, 12b, 12c, 12d), the LED system 10 may include fewer than four or more than four heads. Further, the LED system 10 may include multiple instances of the heat dissipation unit 14 in certain aspects of the present disclosure. For example, in another aspect of the LED system 10, one instance of the heat dissipation unit 14 may be employed for every two instances of the heads, three instances of the head, four instances of the head, five instances of the head, and so on and so forth.

It should be noted that FIG. 4 is a schematic illustration and should not be taken as representative of sizes, shapes, locations, orientations, and the like of componentry of the LED system 10. As an example, in certain aspects of the present disclosure, the heat dissipation unit 14 may include a single interface from which the flexible umbilicals 30a, 30b, 30c, 30d extend. That is, the heat dissipation unit 14 may include a singularly (e.g., centrally) located interface having various ports (e.g., four ports) configured to be coupled with the flexible umbilicals 30a, 30b, 30c, 30d. In certain aspects of the present disclosure, a single pump is configured to bias the liquid through the flexible umbilicals 30a, 30b, 30c, 30d, while in certain other aspects of the present disclosure, each flexible umbilical of the plurality of flexible umbilicals 30a, 30b, 30c, 30d includes a dedicated pump.

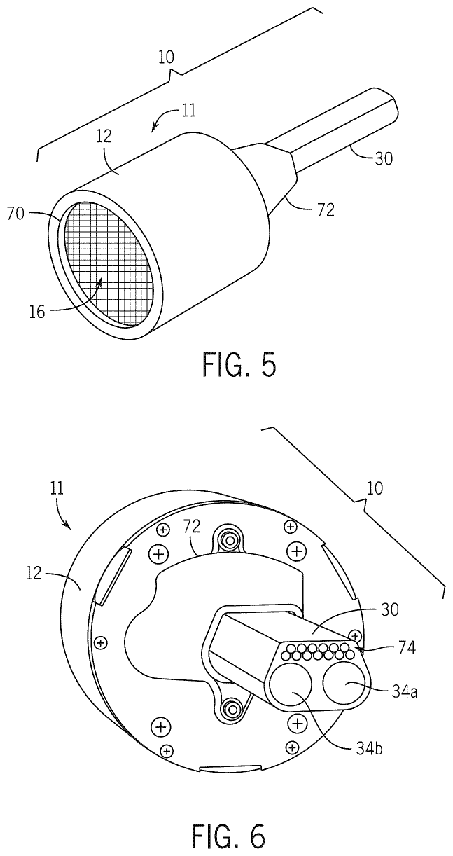

FIG. 5 is a front perspective view of a portion of the LED system 10 of FIG. 1, where the LED head 12 of the LED assembly 11 is coupled to the umbilical 30 (e.g., flexible umbilical) configured to extend to a remote heat dissipation unit (not shown), in accordance with an aspect of the present disclosure. FIG. 6 is a back perspective view of the portion of the LED system 10 of FIG. 5, in accordance with an aspect of the present disclosure. As shown in FIG. 5, a lens 70 may be coupled to an end of the head 12 over the LEDs 16 disposed within the head 12. As shown in FIGS. 5 and 6, a connector 72 may be employed to mount the umbilical 30 to the head 12. As shown in FIG. 6, the umbilical 30 may include the first flow path 34a that operates as a coolant supply to the head 12, the second flow path 34b that operates as a coolant exhaust from the head 12, and a wiring cavity 74 (e.g., one or more wire paths) configured to receive the wiring 32 illustrated in FIG. 1, for example, that electrically couples the LEDs 16 illustrated in FIG. 5 with the LED drivers installed at the heat dissipation unit (not shown).

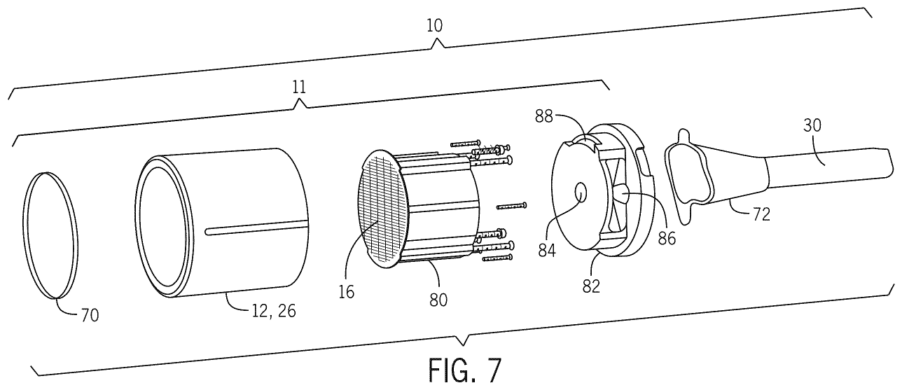

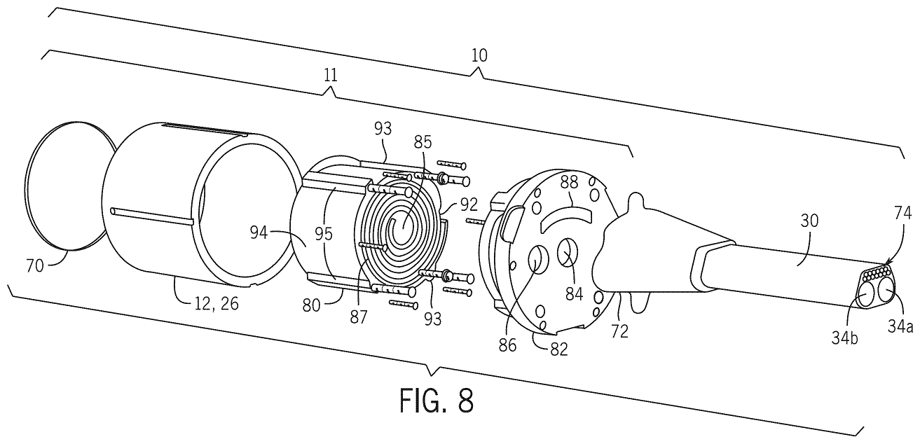

FIG. 7 is an exploded front perspective view of the portion of the LED system 10 of FIG. 5 and FIG. 8 is an exploded back perspective view of the portion of the LED system 10 of FIG. 5, in accordance with an aspect of the present disclosure. As shown in FIGS. 7 and 8, the lens 70 may be configured to couple to an end of the head 12, and a variety of componentry may be configured to extend into the head 12. For example, the LEDs 16 may be disposed within the head 12 such that, when activated, light is emitted through the lens 70 into an external space. Also shown in FIGS. 7 and 8 is a liquid maze cooling plate 80 configured to guide the cooling liquid therethrough and/or toward the LEDs 16. In certain aspects of the present disclosure, the liquid maze cooling plate 80 may act as the heat sink 60 illustrated in (and described above with respect to) FIG. 3 whereby the cooling liquid does not contact the LEDs 16, while in certain aspects of the present disclosure, the liquid maze cooling plate 80 distributes the cooling liquid to the LEDs 16 for liquid immersion. In either case, the liquid maze cooling plate 80 may operate to slow a flow of the cooling liquid and/or extract heat from the cooling liquid to improve an efficiency and/or an amount of heat extraction from the LEDs 16.

In FIGS. 7 and 8, the LED assembly 11 may also include an umbilical interface 82 having various features configured to coordinate with the umbilical 30 (e.g., flexible umbilical). For example, the umbilical interface 82 may include an inlet 84 configured to receive the cooling liquid from the first flow path 34a formed in the umbilical 30 and distribute the cooling liquid to the liquid maze cooling plate 80 (e.g., to a center 85 of the liquid maze cooling plate 80), an outlet 86 configured to receive the cooling liquid from the liquid maze cooling plate 80 (e.g., from an outer region 87 of the liquid maze cooling plate 80) and output the cooling liquid to the second flow path 34b formed in the umbilical 30, and a wiring port 88 (also referred to as an additional wiring cavity) configured to receive the wiring from the wiring cavity 74 of the umbilical 30. In certain aspects of the present disclosure, the umbilical interface 82 may be considered a part of the head 12 of the LED assembly 11. For example, the body 26 and the umbilical interface 82 may form the head 12 of the LED assembly 11. While the umbilical interface 82 is illustrated separate from the body 26 in FIGS. 7 and 8, the umbilical interface 82 may be integrated with the body 26 in certain aspects of the present disclosure.

As previously described with respect to FIGS. 1-4, in aspects of the present disclosure including liquid immersion cooling of the LEDs 16, the thermally conductive dielectric liquid (e.g., cooling liquid) may operate both to extract heat from the LEDs 16 and to prevent arcing that may otherwise be caused by high voltage applications of the LED system 10. The same or similar technical benefits apply to aspects of the present disclosure included in FIGS. 5-8, as described in detail below.

If one or more of the LEDs 16 is wired for relatively low voltage (e.g., less than 60 VDC), the corresponding cable of the wiring (not shown in FIGS. 5-8) in the umbilical 30 needed to carry sufficient power to each drive channel of the LED head 12 may be relatively thick. As an example, 2000 Watt channels at 40 VDC would need to carry approximately 50 Amps, requiring a relatively thick cable. If the voltage is increased to 200 VDC, then the cable could be relatively thin (e.g., 18 AWG cable) because it only needs to carry approximately 10 Amps. However, operating at high voltage can cause electrical arcing if air is the only insulator separating the LEDs 16. For example, one of the LEDs 16 (e.g., a color-driven LED) being driven at relatively high voltage (e.g., 60 VDC or 200 VDC) could be right next to another of the LEDs 16 not being driven for a specific color. This would create a 60 VDC or 200 VDC potential between the pads of the two LEDs 16. To ensure no arcing in air, a relatively large gap (e.g., of multiple millimeters) would typically be needed, preventing compact LED sources being used at high voltage. In accordance with an aspect of the present disclosure employing liquid immersion, however, the thermally conductive dielectric liquid (e.g., cooling liquid) also acts as a dielectric insulator that would prevent high voltage arcing. That is, the thermally conductive dielectric fluid acts as an insulator, preventing high voltage arcing. In this way, liquid immersion cooling enables remote cooling and the ability to use thinner wire gauge using the remote LED head 12 due to the dielectric characteristics of the coolant, along with a compact design of the LED head 12 operable at relatively high voltages compared to traditional configurations.

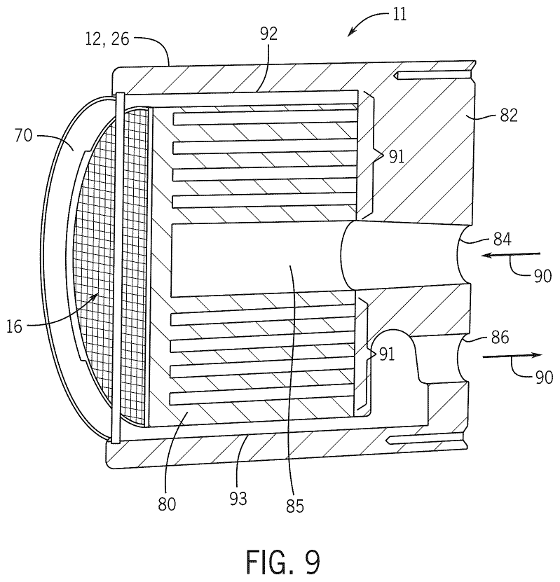

FIG. 9 is a cross-sectional perspective view an LED assembly including an LED head of the portion of the LED system of FIG. 5, including illustration of a fluid pathway through LED head, in accordance with an aspect of the present disclosure. As shown in FIG. 9, the umbilical interface 82 includes the inlet 84 and the outlet 86. Although not shown in FIG. 9, the umbilical interface 82 also may include the wiring port 88 illustrated in FIGS. 7 and 8. As shown in FIG. 9, a fluid 90 (e.g., a thermally conductive dielectric fluid) may pass through the inlet 84 in the umbilical interface 82 to the center 85 of the heat sink 80. In some embodiments, the center 85 of the heat sink 80 may be, or may include, a liquid input cavity within the body 26 of the LED head 12. The fluid 90 may be biased through a tortious path 91 (e.g., a spiral path) of the heat sink 80 until it reaches an outer edge 92 of the heat sink 82. As illustrated in FIG. 8, ridges 93 along the outer edge 92 of the heat sink 82 may abut an inner surface of the body 26 of the LED head 12 and/or a surface of the umbilical interface 82, thereby containing the fluid 90 illustrated in FIG. 9 and forcing the fluid 90 upwardly and toward the LEDs 16 (e.g., between the LEDs 16 and the lens 70) illustrated in FIGS. 8 and 9. In this way, the fluid 90 illustrated in FIG. 9 may contact the LEDs 16 in certain aspects of the present disclosure, although certain other aspects of the present disclosure may not include contact between the fluid 90 and the LEDs 16, as previously described. The fluid 90 then may travel along an opposing edge 94 of the heat sink 80 (e.g., between the opposing edge 94 of the heat sink 80 and the body 26 of the LED head 12), as shown in FIGS. 8 and 9. Additional ridges 95 along the opposing edge 94 of the heat sink 80, as shown in FIG. 8, may abut the inner surface of the body 26 of the LED head 12 and/or the surface of the umbilical interface 82, thereby containing the fluid 90 illustrated in FIG. 9 and forcing the fluid 90 downwardly (e.g., through a liquid output cavity) and toward the outlet 86 of the umbilical interface 82.

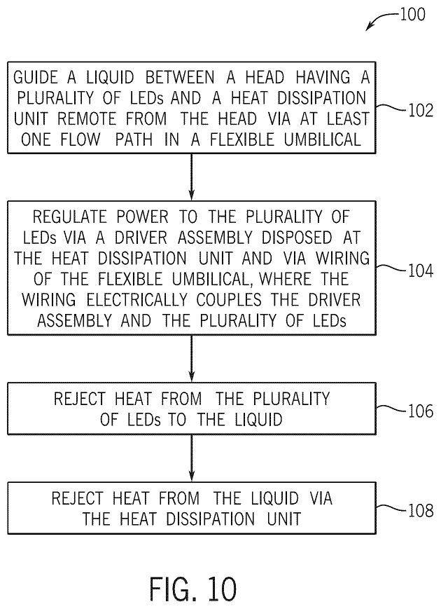

FIG. 10 is a process flow diagram illustrating a method 100 of operating the LED system 10 of FIG. 1 (and/or FIG. 4), in accordance with an aspect the present disclosure. The method 100 in FIG. 10 includes guiding (block 102) a liquid between a head having a plurality of LEDs and a heat dissipation unit remote from the head via at least one flow path (e.g., at least one liquid flow path) in a flexible umbilical. As previously described, the flexible umbilical may include a first flow path (e.g., a first liquid flow path) configured to guide the liquid from the heat dissipation unit to the head, and a second flow path (e.g., a second liquid flow path) configured to guide the liquid from the head to the heat dissipation unit, where the second flow path is fluidly coupled with the first path. A pump may be employed to bias the liquid through the at least one flow path (e.g., through the first flow path and the second flow path) in certain aspects of the present disclosure. If liquid immersion cooling is employed at the head, the liquid may include, for example, a thermally conductive dielectric liquid (e.g., an oil). If a heat sink is employed at the head, the heat sink may be fluidly sealed from the plurality of LEDs and/or a traditional coolant or a water-based liquid (e.g., water, a mixture of water and glycol) may be employed.

The method 100 also includes regulating (block 104) power to the plurality of LEDs via a driver assembly disposed at (e.g., in or on) the heat dissipation unit and wiring of the flexible umbilical. The wiring may electrically couple the driver assembly with the plurality of LEDs disposed at the head. As previously described, offsetting the driver assembly from the head of the LED system substantially reduces a size and/or weight of the head, especially when the LED system is a relatively high power (e.g., 2000 Watts or greater) LED system.

The method 100 also includes rejecting (block 106) heat from the plurality of LEDs to the liquid. As previously described, liquid immersion cooling may be employed where the liquid directly contacts the plurality of LEDs. Additionally or alternatively, a heat sink may be employed where the liquid directly contacts the heat sink and is fluidly isolated from the plurality of LEDs in the head. For example, the heat sink may be disposed in the head, coupled to the head, or otherwise positioned in a heat exchange relationship with the plurality of LEDs disposed in the head.

The method 100 also includes rejecting (block 108) heat from the liquid via the heat dissipation unit. For example, the liquid may be biased back to the heat dissipation unit, where a cooling assembly extracts heat from the heated liquid, thereby cooling the liquid. The cooling assembly may include, for example, a fan configured to generate an air flow over a coil through which the liquid is passed. However, other cooling assemblies (e.g., liquid-to-liquid cooling assemblies) may be employed in certain aspects of the present disclosure.

The systems, methods, and/or techniques described above (e.g., with respect to FIGS. 1-10) enable relatively high-powered LED systems that are practical and functionally convenient. For example, by removing cooling and driver features from an LED head in which a plurality of LEDs is disposed, the LED head is more light weight and/or mobile than traditional configurations of a similar power rating. For these and other reasons, relatively high powered LED systems are made practical by presently disclosed features.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A light-emitting diode (LED) system, comprising:
a head having a plurality of LEDs;
a heat dissipation unit remote from the head; and
an umbilical comprising at least one flow path configured to guide a liquid between the heat dissipation unit and the head.

2. The LED system of claim 1, comprising a driver assembly having a plurality of drivers, wherein the driver assembly is configured to power the plurality of LEDs, the driver assembly is disposed in or on the heat dissipation unit, and the umbilical comprises wiring electrically coupling the driver assembly with the plurality of LEDs.

3. The LED system of claim 1, wherein the liquid comprises a thermally conductive dielectric liquid, and the head is configured to cause the liquid to contact the plurality of LEDs for liquid immersion cooling.

4. The LED system of claim 1, comprising a heat sink fluidly sealed from the plurality of LEDs, wherein the at least one flow path is configured to guide the liquid to the heat sink.

5. The LED system of claim 1, wherein the heat dissipation unit comprises at least one fan configured to generate an air flow to reject heat from the liquid to the air flow.

6. The LED system of claim 1, comprising a pump configured to bias the liquid through the at least one flow path.

7. The LED system of claim 1, wherein the at least one flow path comprises:
a first flow path configured to guide the liquid toward the head; and
a second flow path configured to guide the liquid toward the heat dissipation unit, wherein the second flow path is in fluid communication with the first flow path.

8. The LED system of claim 7, comprising an umbilical interface having an inlet and an outlet, wherein the umbilical interface is coupled to the umbilical and coupled to the head, and wherein the umbilical interface is configured to:
pass the liquid from the first flow path to the head via the inlet; and
pass the liquid from the head to the second flow path via the outlet.

9. A method of cooling a light-emitting diode (LED) system, the method comprising:
guiding a liquid between a head having a plurality of LEDs and a heat dissipation unit remote from the head via at least one flow path defined by an umbilical;
rejecting heat from the plurality of LEDs to the liquid; and
rejecting heat from the liquid via the heat dissipation unit.

10. The method of claim 9, comprising powering the plurality of LEDs via a driver assembly having a plurality of drivers and via wiring in the umbilical electrically coupling the driver assembly with the plurality of LEDs.

11. The method of claim 10, wherein the driver assembly, the plurality of LEDs, or both comprise a power rating of 500 Watts or greater.

12. The method of claim 9, comprising causing the liquid to contact the plurality of LEDs for liquid immersion cooling.

13. The method of claim 9, comprising guiding the liquid to a heat sink fluidly sealed from the plurality of LEDs.

14. The method of claim 13, wherein the heat sink is coupled to or disposed within the head.

15. The method of claim 9, comprising moving the heat dissipation unit via at least one wheel of the heat dissipation unit.

16. The method of claim 9, comprising rejecting heat from the heat dissipation unit via an air flow generated by a fan of the heat dissipation unit.

17. The method of claim 9, comprising biasing the liquid between the head and the heat dissipation unit via a pump.

18. The method of claim 9, wherein guiding the liquid between the head having the plurality of LEDs and the heat dissipation unit remote from the head via the at least one flow path defined by the umbilical comprises:
guiding the liquid toward the head and away from the heat dissipation unit via a first flow path of the at least one flow path; and
guiding the liquid away from the head and toward the heat dissipation unit via a second flow path of the at least one flow path.

19. A light-emitting diode (LED) assembly, comprising:
a head;
a plurality of LEDs disposed in the head
an umbilical interface disposed in, disposed on, or coupled to the head;
an inlet of the umbilical interface;
an outlet of the umbilical interface;
a liquid input cavity within the head, wherein the liquid input cavity is configured receive a liquid from the inlet of the umbilical interface; and
a liquid output cavity within the head, wherein the liquid output cavity is configured to output the liquid to the outlet of the umbilical interface.

20. The LED assembly of claim 19, comprising:
a heat sink comprising, at least partially defining, or fluidly coupled with the liquid input cavity and the liquid output cavity; and
a liquid immersion cavity in which the plurality of LEDs is disposed, wherein the liquid immersion cavity is configured to receive the liquid from the heat sink, the liquid input cavity, or both, and wherein the liquid immersion cavity is configured to output the liquid to the liquid output cavity.
